(19) United States
(12) Patent Application Publication
(10) Pub. No.: US 2026/0246718 A1
(43) Pub. Date: Aug. 20, 2026

(54) INFORMATION TRANSMISSION METHOD AND APPARATUS

(71) Applicant: 1FINITY Inc., Kawasaki-shi (JP)

(72) Inventors: Xin WANG, Beijing (CN); Gang SUN, Beijing (CN); Liqiang JIN, Beijing (CN); Guotong WANG, Beijing (CN)

(73) Assignee: 1FINITY Inc., Kawasaki-shi (JP)

(21) Appl. No.: 19/630,870

(22) Filed: Mar. 27, 2026

Related U.S. Application Data
(63) Continuation of application No. PCT/CN2023/122966, filed on Sep. 28, 2023.

(51) Int. Cl. H04L 41/16; H04L 43/065

(52) U.S. Cl. CPC H04L 41/16; H04L 43/065

(57) ABSTRACT

An information transmission apparatus, provided in a terminal equipment having one or more AI/ML (artificial intelligence/machine learning) features, includes: a first receiver configured to receive first configuration information or second configuration information related to AI/ML unit performance assessment or selection from a network device.

### CROSS-REFERENCE TO RELATED APPLICATION

This application is a continuation application under 35 U.S.C. 111 (a) of International Patent Application PCT/CN2023/122966 filed on Sep. 28, 2023, and designated the U.S., the entire contents of which are incorporated herein by reference.

### TECHNICAL FIELD

This disclosure relates to the field of communication technologies.

### BACKGROUND

In NR Rel-18, research was conducted on New Radio artificial intelligence/machine learning (AI/ML). AI/ML may be used for the following use cases: CSI feedback enhancement, beam management, and positioning enhancement. The CSI feedback enhancement may include CSI prediction and CSI compression; the beam management may include spatial beam prediction and temporal beam prediction; and the positioning enhancement may include direct positioning and AI/ML-assisted positioning. These use cases are only preliminarily selected use cases, and new use cases may be added in Rel-19, for example, AI/ML are used for mobility management.

For 6G, it is assumed that AI/ML are integrated with communications. Hence, there will be more use cases applying AI/ML in New Radio.

With the introduction of these use cases, standardization efforts are underway to develop new protocols, processes, signaling, and other aspects to support the reliable operation of AI/ML and ensure its effective benefits. These protocol related methods and approaches are not only for 5G Advanced standards and commercial networks and devices, but can also be further applied to 6G networks and devices.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

There is no clear consideration and design for monitoring and assessment of inactive AI/ML models/functionalities models/functionalities in NR Rel-18. If there is no such design, there would be no clear mechanism, process and signaling for how to activate AI/ML models/functions for New Radio, how to select models/functionalities, and how to switch models/functionalities.

A method for monitoring inactive AI/ML models/functionalities is to activate them and reuse them as mechanisms defined for monitoring active AI/ML models/functionalities models/functionalities.

However, it was found by the inventor that in functionality-based lifecycle management (LCM), a network (NW) usually does not know model specifics at a terminal (UE) side. Therefore, it is not possible to activate inactive models one by one. Even if the network knows the information of the model, activating all inactive models will result in high costs in terms of RS overhead, signaling overhead, and reporting delay. Therefore, it is a need to provide an effective mechanism to monitor and assess AI/ML models/functionalities that are in an inactive state.

In order to solve at least one of the above problems, embodiments of this disclosure provide an information transmission method and apparatus.

According to one aspect of the embodiments of this disclosure, there is provided an information transmission method, including: for a terminal equipment having one or more AI/ML features, receiving first configuration information or second configuration information related to AI/ML unit performance assessment or selection from a network device.

According to another aspect of the embodiments of this disclosure, there is provided an information transmission method, including: transmitting first configuration information or second configuration information related to AI/ML unit performance assessment or selection by a network device to a terminal equipment.

According to a further aspect of the embodiments of this disclosure, there is provided an information transmission apparatus, provided in a terminal equipment having one or more AI/ML features, the apparatus including: a receiving unit configured to receive first configuration information or second configuration information related to AI/ML unit performance assessment or selection from a network device.

An advantage of the embodiments of this disclosure exists in that a process of monitoring/assessing inactive AI/ML models/functionalities models/functionalities may be supported and clearly defined, and use of gains of AI/ML becomes reliable.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of an information transmission method of an embodiment of this disclosure;

FIGS. 3A-3C are schematic diagrams of a structure of an AI/ML hierarchical functionality of embodiments of this disclosure;

FIG. 4 is a schematic diagram of an AI/ML model/functionality and related information thereof of embodiments of this disclosure;

FIG. 5 is an interaction graph of an information interaction method for activating performing assessment or monitoring at a terminal side for an AI/ML unit of embodiments of this disclosure;

FIG. 6 is an interaction graph of an information interaction method for switching performing assessment or monitoring at a terminal side for an AI/ML unit of embodiments of this disclosure;

FIG. 7 is an interaction graph of an information interaction method for activating performing assessment or monitoring at a network side for an AI/ML unit of embodiments of this disclosure;

FIG. 8 is an interaction graph of an information interaction method for switching performing assessment or monitoring at a terminal side for an AI/ML unit of embodiments of this disclosure;

FIG. 9 is an interaction graph of a terminal AI/ML capability query and report of embodiments of this disclosure;

FIG. 10 is a schematic diagram of AI/ML beam management of TX beam prediction of embodiments of this disclosure;

FIG. 11 is another schematic diagram of the information transmission method of embodiments of this disclosure;

FIG. 12 is a schematic diagram of an information transmission apparatus of an embodiment of this disclosure;

FIG. 13 is another schematic diagram of the information transmission apparatus of embodiments of this disclosure;

FIG. 14 is a block diagram of a systematic structure of a terminal equipment of an embodiment of this disclosure; and

FIG. 15 is a block diagram of a systematic structure of a network device of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any level, which may, for example, include but not limited to the following communication protocols: 1G (generation), 2G, 2.5G, 2.75G, 3G, 4G, 4.5G, 5G, New Radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, a machine to machine (M2M) terminal, and a terminal supporting sidelink communication, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment.

Scenarios in the embodiments of this disclosure shall be described below by way of examples; however, this disclosure is not limited thereto.

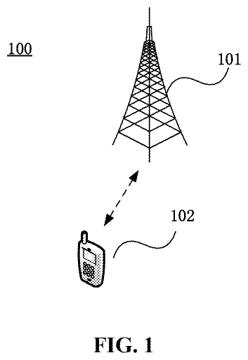

FIG. 1 is a schematic diagram of a communication system of an embodiment of this disclosure, in which a case where a terminal equipment and a network device are taken as examples is schematically shown. As shown in FIG. 1, a communication system 100 may include a network device 101 and a terminal equipment 102. For the sake of simplicity, an example having only one terminal equipment and one network device is schematically given in FIG. 1; however, embodiments of this disclosure is not limited thereto.

In embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). High-layer signaling may also be, for example, medium access control (MAC) signaling, or an MAC control element (MAC CE); however, this disclosure is not limited thereto.

In embodiments of this disclosure, one or more AI/ML models may be configured and/or run by the network device and/or the terminal equipment. The AI/ML model may be used for various signal processing functionalities in wireless communication, such as CSI prediction, CSI compression, beam prediction, and positioning management, etc.; however, this disclosure is not limited thereto.

### Embodiment of a First Aspect

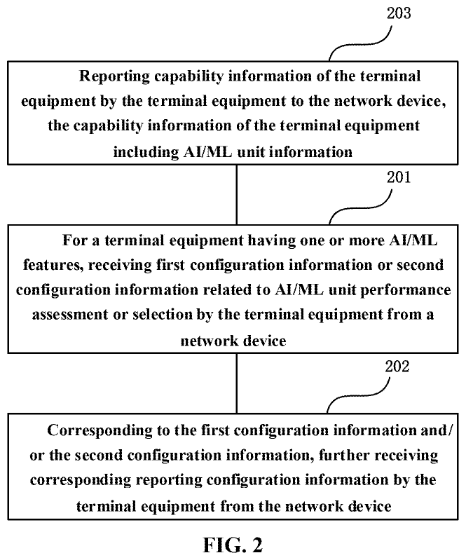

Embodiments of this disclosure provide an information transmission method. FIG. 2 is a schematic diagram of the information transmission method of embodiments of this disclosure. As shown in FIG. 2, the method includes:

201: for a terminal equipment having one or more AI/ML features, receiving first configuration information or second configuration information related to AI/ML unit performance assessment or selection by the terminal equipment from a network device.

It should be noted that FIG. 2 only schematically illustrates embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, the AI/ML unit may also be referred to as an AI/ML element.

In some embodiments, the AI/ML unit is a first AI/ML unit or a second AI/ML unit, or includes a first AI/ML unit and a second AI/ML unit.

In some embodiments, the first AI/ML unit includes one or more second AI/ML units. It may also be said that the first AI/ML unit is implemented by one or more second AI/ML units.

In some embodiments, the AI/ML unit corresponds to an AI/ML feature and/or an AI/ML functionality and/or an AI/ML logical model and/or an AI/ML physical model.

In some embodiments, the functionality refers to an AI/ML feature/feature group enabled by configuration, wherein the configuration is supported based on a condition indicated by a UE capability.

For example, the functionality may be using AI/ML to perform spatial beam prediction, or may be using AI/ML to perform temporal beam prediction, or applying AI/ML to CSI prediction, or using AI/ML for direct positioning, or using AI/ML for assisted positioning, etc.

In some embodiments, the terminal equipment having an AI/ML feature or AI/ML functionality is implemented by one or more AI/ML models. An AI/ML model may refer to a logical model or one or more physical models.

In some embodiments, the first AI/ML feature includes one or more second AI/ML features, or the first AI/ML feature includes one or more first AI/ML functionalities; and/or, the first AI/ML functionality includes one or more second AI/ML functionalities, or the first AI/ML functionality includes one or more first models; and/or, the first AI/ML model includes one or more second AI/ML models.

In some embodiments, a terminal capability list gives relevant features and/or feature groups and parameters in each feature group for each use case of NR AI/ML. The terminal equipment report support of these features and feature groups according to a capability of its own. In subsequent operations of AI/ML models or capabilities, one definition is to call an enabled feature as a functionality.

For example, for beam management, there may exist an AI/ML feature of beam spatial domain prediction, which may also include two features, transmit beam prediction and beam pair prediction. When a system enables or activates the AI/ML feature of beam spatial domain prediction of the terminal equipment, it may be deemed that the terminal equipment has an AI/ML functionality of beam spatial domain prediction.

In some embodiments, a terminal equipment may also have multiple AI/ML features, such as an AI/ML feature with beam spatial domain prediction, an AI/ML feature with CSI prediction, and an AI/ML feature with direct positioning, etc.

Table 1 is an example in which a list of corresponding features, feature groups, feature units, conditional parameter information and assistance parameter information and related indices are predefined for AI/ML features. The network may obtain corresponding information of terminal AI/ML via queries and responses with the terminal.

TABLE 1

| | | | Conditional |
|---|---|---|---|
| Feature | Index | Feature group | information |
| AI/ML spatial | 0-1 | Transmit beam | 1) SetB information |
| domain management | | management | 2) Beam information |
| | 0-2 | Beam pair | |
| | | management | |

For better understanding of the AI/ML unit of the terminal equipment by the network device, more tables are usually needed, such as input and output information, assistance information, etc. Especially for the functionality-based AI/ML lifecycle management (LCM) studied in Rel-18, providing more information by the terminal equipment may facilitate fine control of the AI/ML unit of the terminal equipment by the network device.

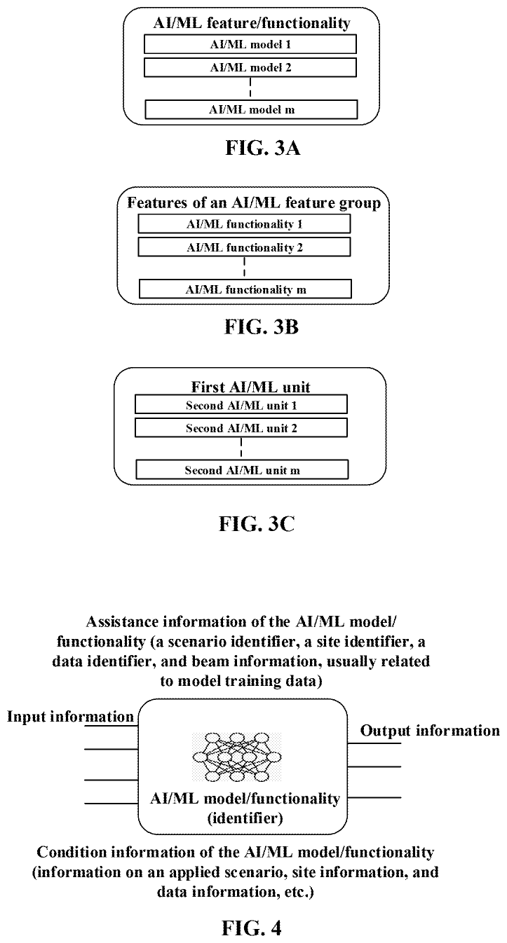

FIGS. 3A-3C are schematic diagrams of a structure of an AI/ML hierarchical functionality of embodiments of this disclosure. As shown in FIG. 3A, an AI/ML feature/functionality includes multiple AI/ML models, as shown in FIG. 3B, a feature of an AI/ML feature group includes multiple AI/ML functionalities, and as shown in FIG. 3C, the first AI/ML unit includes multiple second AI/ML units.

What described above is only an example of displaying a two-level AI/ML hierarchical functional structure at the terminal side, and a structure of more than two levels may be used as needed. When a structure with more two levels is used, a third-level or fourth-level unit and higher-level units may also include the above structure.

It should be noted that in the subsequent text of this disclosure, more description shall be given by using the AI/ML unit, the first AI/ML unit and the second AI/ML unit to more clearly express a mutual hierarchical relationship. In actual network devices, terminal equipments and network systems, more description shall be given by using AI/ML features, AI/ML functionalities and AI/ML models.

In some embodiments, the terminal equipment side is provided with an AI/ML unit, such as an AI/ML model, and the terminal equipment performs monitoring or assessment on a performance of the AI/ML model.

For example, for an inactive AI/ML unit, the terminal equipment assesses a performance of the inactive AI/ML unit, and performs monitoring or assessment on a performance of an active AI/ML unit.

In operation 201, for the terminal equipment having one or more AI/ML features, the terminal equipment receives the first configuration information or the second configuration information related to AI/ML unit performance assessment or selection from the network device.

In some embodiments, the first configuration information includes one or more of performance information, activation trigger information, or AI/ML unit indication information related to performance assessment or selection associated with AI/ML activation.

In some embodiments, the first configuration information corresponds to the active AI/ML unit. For example, for an AI/ML feature of the terminal equipment, when all AI/ML units included in the AI/ML feature are not activated, the first configuration information includes performance information related to determining activation of the AI/ML unit.

In some embodiments, the performance information includes one or more pieces of the following information for assessing an AI/ML unit related to performance indicators:
a performance threshold for assessing AI/ML activation by a terminal side;
a performance threshold range for assessing AI/ML activation by the terminal side;
a reporting performance threshold for assessing AI/ML activation by a network side; and
a reporting performance threshold range for assessing AI/ML activation by the network side.

In some embodiments, the performance information further includes one or more pieces of the following performance preference indication information:
indication information for selecting an AI/ML unit with a best performance;
indication information for selecting an AI/ML unit with a performance higher than or equal to the performance threshold or with a best reporting performance threshold;
indication information for selecting an AI/ML unit with a performance satisfying the performance threshold range or the reporting performance threshold range;
indication information for selecting an AI/ML unit having a corresponding input reference signal with lowest overhead;
indication information for selecting an AI/ML unit having a corresponding output signal with lowest overhead;
indication information for selecting an AI/ML unit satisfying one of the performance indicators and having a corresponding input reference signal with lowest overhead; and
indication information for selecting an AI/ML unit satisfying one of the performance indicators and having a corresponding output signal with lowest overhead.

In some embodiments, the activation trigger information includes one or more pieces of the following information:
a counter parameter triggering an activation request;
a timer parameter triggering an activation request; and
other event parameters triggering an activation requests.

In some embodiments, the counter or timer is usually used jointly with the performance threshold,
for example, if the counter parameter is n, when an event higher than the threshold consecutively occurs n times, the counter is triggered;
for example, if the timer parameter is t, when a duration of an event higher than the threshold is t, the timer will be triggered.

When the performance indicators are other, the triggering condition may be inferred.

In some embodiments, other events may correspond to triggering conditions of the counter or timer in combination with other AI/ML unit operation indicators, such as a unit power consumption indicator, a level indicator, a memory indicator, and a processing latency indicator, etc.

In some embodiments, triggering may be performed only when a specific indicator is satisfied and the counter or timer indicator is met.

When the triggering conditions are met, the terminal equipment transmits an activation request to the network device according to the configuration.

In some embodiments, the AI/ML unit indication information includes one or more pieces of the following information:
AI/ML assistance information for indicating assessment of an AI/ML unit having the assistance information;
AI/ML input parameter or output parameter information for indicating assessment of an AI/ML unit having the input parameter or output parameter; or
AI/ML condition information for indicating assessment of an AI/ML unit satisfying the condition information.

In some embodiments, as shown in FIG. 2, the method further includes:

202: corresponding to the first configuration information and/or the second configuration information, further receiving corresponding reporting configuration information by the terminal equipment from the network device.

The reporting configuration information includes a part of information of the first configuration information and/or the second configuration information.

In some embodiments, the reporting configuration information includes a reporting behavior after indicating the terminal equipment to perform the performance assessment or selection on the AI/ML unit, and comprises one or more of the following configurations related to reporting content:
configuration related to an AI/ML switching or activation request;
information and configuration related to an AI/ML switching or activation unit;
information and configuration related to an AI/ML switching or candidate unit
reporting configuration related to AI/ML unit input configuration information;
reporting configuration related to AI/ML unit output configuration information;
reporting configuration related to AI/ML unit assistance information;
reporting configuration related to AI/ML unit condition information; or
reporting configuration related to AI/ML performance information.

In some embodiments, the reporting configuration information includes a reporting behavior after indicating the terminal equipment to perform the performance assessment or selection on the AI/ML unit, and the configurations related to reporting content include one or more of the following contents:
input configuration information of a selected AI/ML unit and/or performance information of a selected AI/ML unit;
output configuration information of the selected AI/ML unit and/or performance information of the selected AI/ML unit;
assistance information of the selected AI/ML unit and/or performance information of the selected AI/ML unit;
condition information of the selected AI/ML unit and/or performance information of the selected AI/ML unit; and
an identifier of the selected AI/ML unit and/or performance information of the selected AI/ML unit.

In some embodiments, the selected AI/ML unit is one or more units.

In some embodiments, the selected AI/ML unit is in an inactive state.

In some embodiments, selection of the contents is based on the first configuration information or the second configuration information

In some embodiments, a format of reporting the contents is based on the reporting configuration information.

In some embodiments, the reporting configuration information includes a reporting behavior after indicating the terminal equipment to perform the performance assessment or selection on the AI/ML unit, and includes one or more of the following reporting modes and resource configuration information:
periodic reporting, aperiodic reporting, or semi-persistent reporting;
configuring a dedicated PRACH resource, and performing trigger reporting of an AI/ML switching or activation request; or
performing reporting based on a dedicated PUCCH or a dedicated MAC CE or a dedicated RRC message.

In some embodiments, reporting identical to that adopted in transmitting the activation request by the terminal equipment to the network device according to the configuration may be adopted in transmitting the switching request by the terminal equipment to the network device according to the configuration, that is, the reporting configuration, resources and contents may be shared. This is because both of them correspond to requesting for activating an AI/ML unit. A difference is that during switching of the AI/ML unit, an activated AI/ML unit needs to be deactivated or stopped. For a new AI/ML unit requested for activating, relevant signaling and processes may adopt a consistent framework.

At this point, in operation 201, the terminal equipment may further receive third configuration information related to the AI/ML unit performance assessment or selection from the network device. The third configuration information may consistently correspond to assessment of activation and switching, and reporting information relative to the third configuration information may further be configured accordingly. The reporting information may consistently support a request for AI/ML activation and switching and reporting of related contents.

Hence, the third configuration information may include one or more performance information, activation/switching trigger information or AI/ML unit indication information related to performance assessment or selection associated with AI/ML activation/switching.

In some embodiments, the performance information includes one or more pieces of following information related to performance indicators for assessment of the AI/ML unit:
a performance threshold for assessing AI/ML activation/switching by a terminal side;
a performance threshold for assessing AI/ML activation/switching by the network side; and
a reporting performance threshold range for assessing AI/ML activation/switching by the network side.

Corresponding to a case where there is already an activated AI/ML unit, after the network side receives the activation request from the terminal equipment, if it is determined that the AI/ML unit may be activated, the network side will not only transmit activation signaling to the terminal equipment, but also transmit deactivation signaling to the terminal equipment to deactivate the activated AI/ML unit.

In order to avoid ambiguities in indicating AI/ML units, it is needed to indicate separately via indication messages of relevant AI/ML units. Or, by default, for a first AI/ML unit of the terminal equipment, if there is already an activated second AI/ML unit, when the second AI/ML unit is in an active state and the terminal equipment receives an activation command from the network device for the first AI/ML unit, the terminal equipment will stop operation of the activated AI/ML unit. The terminal equipment activates a new AI/ML unit according to information of the activation command.

In some embodiments, in addition to the information related to the performance indicators in the performance information, other information (such as performance preference indication information, activation/switching trigger information, and AI/ML unit indication information in the performance information) in the third configuration information may be identical or similar to relevant information in the first configuration information or second configuration information (such as the performance preference indication information, the activation trigger information, the switching trigger information, and AI/ML unit indication information in the performance information), and specific contents thereof shall not be repeated herein any further.

In some embodiments, as shown in FIG. 2, the method further includes:

203: reporting capability information of the terminal equipment by the terminal equipment to the network device, the capability information of the terminal equipment including AI/ML unit information.

In some embodiments, the AI/ML unit information includes one or more pieces of the following information:
according to a query of the network device, whether the first AI/ML unit and/or the second AI/ML unit is/are supported;
whether there is only one first AI/ML unit and/or second AI/ML unit or there are multiple first AI/ML units and/or second AI/ML units;
a number/numbers of the first AI/ML unit and/or the second AI/ML unit that is/are queried;
the number of the second AI/ML units in the first AI/ML unit that is queried;
a model identifier of the AI/ML unit that is queried;
assistance information of the AI/ML unit that is queried;
condition information of the AI/ML unit that is queried; and
input and output configuration information of the AI/ML unit that is queried.

In some embodiments, content and/or a format of the reporting is/are predefined and/or configured by the network device.

In some embodiments, for the AI/ML unit activation, assessment or monitoring may be performed at the terminal side, or, assessment or monitoring may be performed at the network side.

In some embodiments, for the AI/ML unit switching, assessment or monitoring may be performed at the terminal side, or, assessment or monitoring may be performed at the network side.

Detailed explanations are given below.

FIG. 4 is a schematic diagram of the AI/ML model/functionality and related information thereof of embodiments of this disclosure.

In some embodiments, for an AI/ML model or functionality, a mode for indicating is indicating it by an identifier (ID) of the model or functionality, which may be simply expressed as an identifier of an AI/ML unit.

However, in many cases, there may be no identification information, and a corresponding unit may be indicated by input information, output information, condition information, assistance information, etc., of the AI/ML unit.

The input information may refer to configuration information related to the input reference signal of the unit, and the number of dimensions of an input signal may possibly be related to overhead associated with the use case, such as input reference signal overhead in beam management.

The output information may refer to configuration information related to output information of the unit. For example, for a use case of CSI compression, the number of bits of CSI feedback information output by the terminal is a core indicator of the AI/ML unit. Corresponding to identical input signals, the lower the number of output bits, the higher a compression ratio, and it may also be deemed that overhead of output or feedback is lower.

It should be noted that the assistance information and condition information of the AI/ML unit are not definitely delimited. It may be simply deemed that the condition information is more specific to description of the AI/ML unit itself, that is, application conditions of the AI/ML unit (such as an application scenario, an application site, an application configuration, and applied data, etc., and may also be storage information, power consumption information, processing latency information, etc., related to the AI/ML unit of the terminal), and the assistance information is more specific to description of characteristics of input data of the AI/ML unit.

In some embodiments, in the reporting of the capability of the terminal, via the reporting of one or more of the above information (identification information, input output information, assistance information, and condition information), the network device identifies or understands the information of the AI/ML unit in the terminal equipment.

The network device may indicate, control and operate an AI/ML unit to which it corresponds via the information.

FIG. 5 is an interaction graph of an information interaction method for activating performing assessment or monitoring at a terminal side for an AI/ML unit of embodiments of this disclosure. As shown in FIG. 5, the method includes:
transmitting a request for AI/ML capability query by the network device to the terminal equipment;
generating AI/ML capability information by the terminal equipment, including AI/ML unit information, such as information of the first AI/ML unit and/or the second AI/ML unit;
reporting terminal equipment capability information by the terminal equipment to the network device, including AI/ML unit information, such as one or more pieces of identification information, input output information, assistance information, and condition information, etc.;
transmitting AI/ML performance information by the network device to the terminal equipment, which may include performance indicators, and performance preference information, etc;
transmitting AI/ML unit input reference signal configuration information by the network device to the terminal equipment;
transmitting AI/ML unit reporting configuration information by the network device to the terminal equipment, which may include one or more of a configuration related to an AI/ML switching or activation request, information and configuration related to an AI/ML switching or activation unit, information and configuration related to an AI/ML switching or candidate unit, a reporting configuration related to AI/ML unit input and output configuration information, a reporting configuration related to AI/ML unit assistance information, a reporting configuration related to AI/ML unit condition information, and a reporting configuration related to AI/ML performance information, etc.;
performing assessment on an inactive AI/ML unit by the terminal equipment;
reporting an AI/ML information or activation request by terminal equipment to the network device; and
performing AI/ML activation/enabling by the network device.

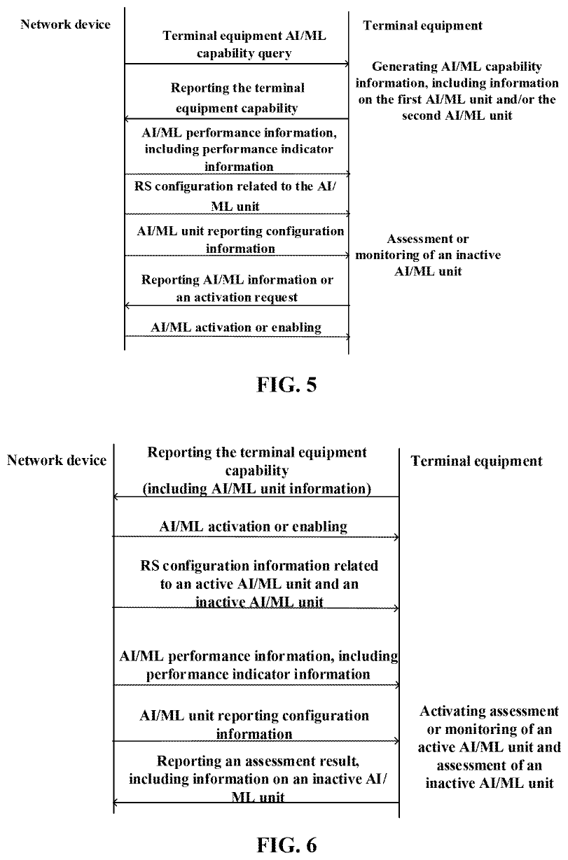

FIG. 6 is an interaction graph of an information interaction method for switching performing assessment or monitoring at a terminal side for an AI/ML unit of embodiments of this disclosure. As shown in FIG. 6, the method includes:
reporting an AI/ML information or activation request by the terminal equipment to the network device;
performing AI/ML activation/enabling by the network device;
transmitting input reference signal configuration information for an activated AI/ML unit and an inactive AI/ML unit by the network device to the terminal equipment;
transmitting AI/ML performance information by the network device to the terminal equipment, which may include performance indicators, and performance preference information, etc;
transmitting AI/ML unit reporting configuration information by the network device to the terminal equipment, which may include one or more of a configuration related to an AI/ML switching or activation request, information and configuration related to an AI/ML switching or activation unit, information and configuration related to an AI/ML switching or candidate unit, a reporting configuration related to AI/ML unit input and output configuration information, a reporting configuration related to AI/ML unit assistance information, a reporting configuration related to AI/ML unit condition information, and a reporting configuration related to AI/ML performance information, etc.;
performing monitoring or assessment on an activated AI/ML unit and assessment of an inactive AI/ML unit by the terminal equipment;
reporting an assessment result by the terminal equipment to the network device, including inactive AI/ML unit information, such as one or more of identification information, input output information, assistance information, and condition information, etc.

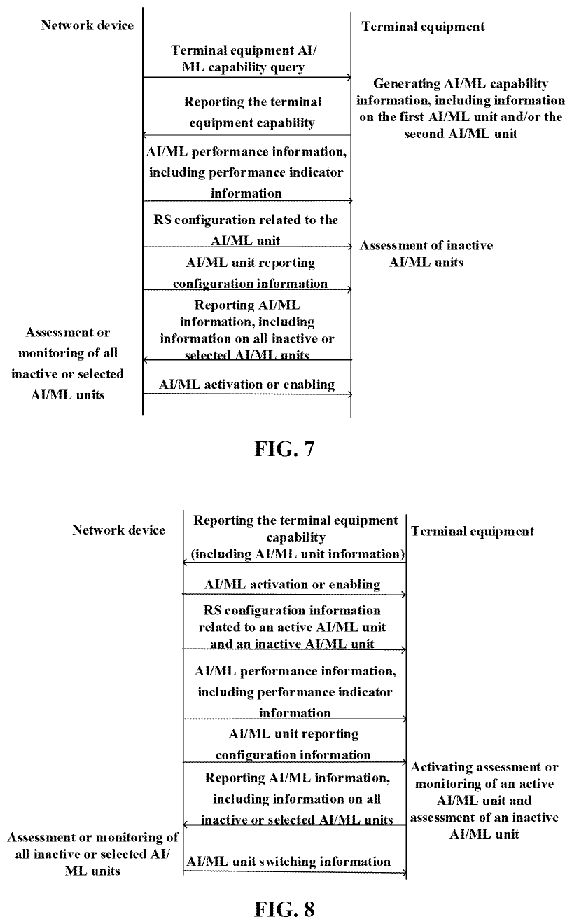

FIG. 7 is an interaction graph of an information interaction method for activating performing assessment or monitoring at a network side for an AI/ML unit of embodiments of this disclosure. As shown in FIG. 7, the method includes:
transmitting an AI/ML capability query request by the network device to the terminal equipment;
generating AI/ML capability information by the terminal equipment, including AI/ML unit information, such as information of the first AI/ML unit and/or the second AI/ML unit;
reporting terminal equipment capability information by the terminal equipment to the network device, including AI/ML unit information, such as one or more pieces of identification information, input output information, assistance information, and condition information, etc.;
transmitting AI/ML performance information by the network device to the terminal equipments, which may include performance indicators, and performance preference information, etc.;
transmitting AI/ML unit input reference signal configuration information by the network device to the terminal equipment;
transmitting AI/ML unit reporting configuration information by the network device to the terminal equipment, which may include one or more of a configuration related to an AI/ML switching or activation request, information and configuration related to an AI/ML switching or activation unit, information and configuration related to an AI/ML switching or candidate unit, a reporting configuration related to AI/ML unit input and output configuration information, a reporting configuration related to AI/ML unit assistance information, a reporting configuration related to AI/ML unit condition information, and a reporting configuration related to AI/ML performance information, etc.;
performing assessment of an inactive AI/ML unit by the terminal equipment;
reporting AI/ML information by the terminal equipment to the network device, including information of all inactive or selected AI/ML units, such as one or pieces of identification information, input and output information, assistance information, and condition information, etc.;
performing assessment or monitoring on all inactive or selected AI/ML units by the network device; and
performing AI/ML activation or enabling by the network device.

FIG. 8 is an interaction graph of an information interaction method for switching performing assessment or monitoring at a terminal side for an AI/ML unit of embodiments of this disclosure.

As shown in FIG. 8, the method includes:
reporting an AI/ML information or activation request by the terminal equipment to the network device;
performing AI/ML activation or enabling by the network device;
transmitting input reference signal configuration information for an activated AI/ML unit and an inactive AI/ML unit by the network device to the terminal equipment;
transmitting AI/ML performance information by the network device to the terminal equipment, which may include performance indicators, and performance preference information, etc;
transmitting AI/ML unit reporting configuration information by the network device to the terminal equipment, which may include one or more of a configuration related to an AI/ML switching or activation request, information and configuration related to an AI/ML switching or activation unit, information and configuration related to an AI/ML switching or candidate unit, a reporting configuration related to AI/ML unit input and output configuration information, a reporting configuration related to AI/ML unit assistance information, a reporting configuration related to AI/ML unit condition information, and a reporting configuration related to AI/ML performance information, etc.;
performing monitoring or assessment on an activated AI/ML unit and assessment of an inactive AI/ML unit by the terminal equipment;
reporting AI/ML information by the terminal equipment to the network device, including information of all inactive or selected AI/ML units, such as one or pieces of identification information, input and output information, assistance information, and condition information, etc.;
performing assessment or monitoring on all inactive or selected AI/ML units by the network device; and
transmitting AI/ML unit switching information by the network device to the terminal equipment.

Contents concerned in the above steps shall be described below in detail.

### 1) Regarding UE Capability

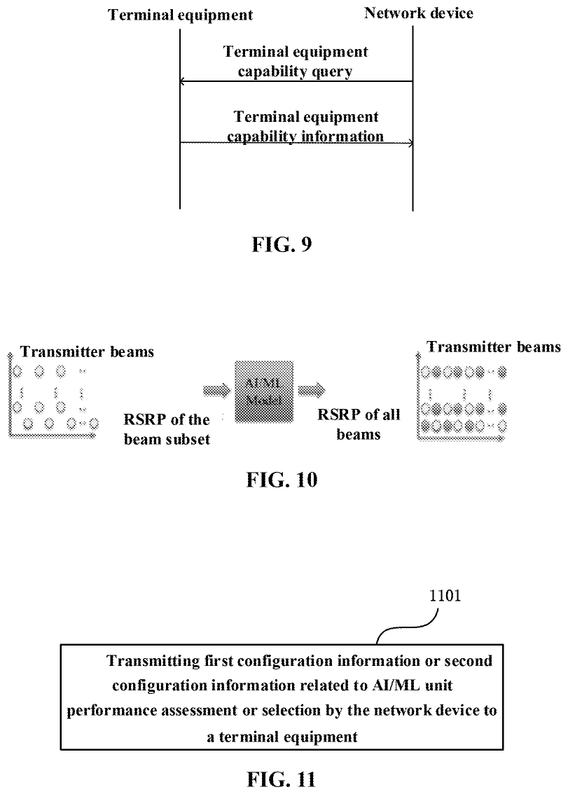

FIG. 9 is an interaction graph of a terminal AI/ML capability query and report of embodiments of this disclosure. As shown in FIG. 9, the network device transmits a terminal equipment capability query to the terminal equipment, and the terminal equipment reports the terminal equipment capability information to the network device according to the query.

In some embodiments, the network device (such as a gNB) transmits the terminal equipment capability query, which may include a capability query related to the AI/ML unit, such as information query about an AI/ML feature/feature group or functionality or model. Thus, the terminal equipment transmits its AI/ML capability report to the network device side.

In some embodiments, specifically, the terminal equipment capability query may include query/queries related to the first AI/ML unit and/or the second AI/ML unit. Hence, in the terminal equipment capability report, the terminal equipment may report information on its first unit and/or second unit.

For example, the network device may query the terminal equipment side for features related to beam management, the features including information on a first AI/ML functional unit, such as a feature supporting (or not supporting) spatial domain beam prediction and/or a feature supporting (or not supporting) time domain prediction. Furthermore, the queries may include second unit information, such as whether there are multiple models/functionalities and/or how many models or functionalities are used for spatial/time domain beam prediction.

Therefore, the terminal equipment transmits its AI/ML capability information in the terminal equipment capability report. For an AI/ML feature/feature group, the report may include information on its first AI/ML unit and/or second AI/ML unit or more information to the network device. Such information may include detailed information on the first unit and/or the second unit, or simply indicate the number of the first unit and/or the second unit, or simply indicate existence of multiple first units and/or second units.

In some embodiments, content and/or a format of the reporting is/are predefined and/or configured by the network device. For example, the network device may further configure further specific queries of units, and t terminal equipment reports such information only when such specific queries are configured.

In some embodiments, the capability information of the terminal equipment, such as the AI/ML features and parameter lists, is given by predefinition, such as Table XXX, and the network device and the terminal equipment complete corresponding queries and responses based on items in the table.

For example, for the spatial domain prediction, the network device may further query whether a beam information-specific model is supported.

For example, as one of the unit condition information or assistance information, specific beam information may be a beam index, a beam angle, a beam codebook, a beam pattern, a beam width, or other beam information. When the terminal equipment is queried, it will accordingly provide the assistance information of the AI/ML unit in its UE report. Another example of the assistance information or condition information may be information related to wireless scenarios.

For example, different wireless scenarios may need to be supported by using different AI/ML units, such as indoor units and outdoor units. In addition, it may be information related to mobility, and different moving speeds or mobilities may need different AI/ML units, such as units for low mobilities or units for high mobilities.

It should be noted that the condition information here is more specific to description of application conditions of the AI/ML unit, while the assistance information is more specific to description of data features targeted by the unit. Based on different processes, the two may or may not need to be distinguished.

### 2) Regarding Monitoring or Assessment of Activation of an Inactive AI/ML Unit

In some embodiments, before activating or enabling the AI/ML unit, it is needed to compare performances of using traditional methods (non-AI methods) with performances of using AI/ML units. The network device may possibly need to notify the terminal equipment of performance information and/or performance indicator information, and accordingly configure reporting information needed by the network.

In some embodiments, the performance indicator information is related to an intention of using AI/ML units by the network device. For example, the network device hopes for lowering overhead of input reference signals or reducing delay needed in implement of unit functionalities by using the AI/ML units. In this case, if needed, the network device may transmit a threshold of performance metrics, an indication serving as the performance indicator information and performance preference information to the terminal equipment. Reporting related to unit input parameters may be configured in a corresponding reporting configuration.

For example, FIG. 10 is a schematic diagram of AI/ML beam management of TX beam prediction of embodiments of this disclosure. As shown in FIG. 10, in beam management, the terminal equipment may report its capability to predict TX beams, and may serve as the first AI/ML unit or the second AI/ML unit. In brief, it is referred to as an AI/ML beam management unit, wherein output of the unit is RSRP of all beams, referred to as SetA, and input of the unit is RSRP of beam subsets, referred to as SetB.

In a traditional beam management method, the terminal equipment may report a maximum total number of configured NZP-CSI-RS resources supported by the terminal equipment, to measure L1-RSRP and/or other L1-RSRP capability information related to beam management (maxNumberCSI RS Resource, maxNumberCSI RS ResourceTwoTx, and maxNumber SSB CSI RS ResourceOneTx, etc.), and such information may be directly reused for SetA in this example, or, it may be reported independently in an AI/ML beam management feature capability report. It may be assumed that a maximum number of RS (CSI-RS, SSB) resources, maximum L1-RSRP correspondingly measured in a traditional method, and a corresponding total number of beams are identical to the number of beams measured based on AI/ML (the number of beams/L1-RSRP of SetA).

In this AI/ML unit, it may include multiple second AI/ML units, each corresponding to a specific SetB. Different SetBs have different beam/L1 RSRP subsets and have different SetB/SetA ratios. For example, if the number beams of SetA is 16 and the number beams of SetB is 4, the ratio is 0.25; and if the number beams of SetB is 8, the ratio is 0.5.

In one situation, the network device expects to reduce delay, RS consumption and signaling overhead of the AI/ML unit used in the beam management. There are two mechanisms, one is monitoring/assessment of inactive AI/ML units at the terminal equipment side, and the other is monitoring/assessment of AI/ML units at the network device side.

Likewise, in CSI prediction, different AI/ML units are needed to support different movement speeds and/or different scenarios, such as cities, suburbs, highways, and high-speed trains, etc.

For an inactive AI/ML unit, the network device needs to configure the terminal equipment according to its preference for using AI/ML units and direct the terminal equipment to select an AI/ML unit.

In this example, the input configuration may involve RS configuration of its measurement window, such as how many CSI RS cases will be used, and intervals between CSI RS cases, etc. The assistance information may include a movement speed or mobility information.

In some embodiments, a universal mechanism may be used for AI/ML units at other terminal equipment sides. Likewise, the mechanism and process proposed in embodiments of this disclosure may be applicable to all use cases where AI/ML units are deployed at terminal equipment sides.

In some embodiments, for the monitoring/assessment of inactive AI/ML units at the terminal side, a process includes steps as follows:
step 1: configuring AI/ML unit input reference signal resources by the network device for the terminal equipment based on the terminal equipment capability report related to AI/ML features;
step 2: configuring reporting configuration information related to the terminal equipment by the network device, wherein the configuring may be performed based on an existing reporting framework, such as configuring based on a CSI reporting framework;
step 3: based on the terminal capability information, configuring the terminal equipment by the network device to perform AI/ML monitoring/assessment, including performance information, performance indicator information and event trigger information;
step 4: configuring a report related to AI/ML activation by the network device for the terminal equipment;
step 5: when the terminal equipment detects based on the performance indicators that the performance of the second AI/ML unit matches the performance information and satisfies an activation event trigger condition, activating a report/request to AI/ML by the terminal equipment, which may include input configuration information/information identifier of the selected AI/ML unit, or assistance information/condition information (or corresponding information identifier), or an ID of the selected unit; and
step 6: making response by the network device, and activating the selected AI/ML unit via the input information, assistance information, or ID.

In some embodiments, the assistance information or condition information may be other conditions or parameters able to distinguish AI/ML units.

For example, different wireless scenarios may need to be supported by using different AI/ML units, such as indoor units and outdoor units. In addition, different moving speeds or mobilities may need different AI/ML units, such as units for low mobilities or units for high mobilities.

The assistance information or condition information may be obtained by the network device via the terminal equipment capability report. With this assistance information or condition information, even there is no unit identifier, the network device and the terminal equipment may have a common understanding of the selected AI/ML unit.

When there is more than one unit to which the assistance information or condition information corresponds, according to the performance indicator information indicated by the network, the terminal selects one with a best corresponding indicator, such as one with a highest accuracy, or one with lowest input overhead.

In step 3, the network device may configure the terminal equipment to perform AI/ML assessment/monitoring on the first unit and not to further configure the second unit. Performance indicators/standards used in the assessment/monitoring may be configured.

For the above beam management, that is, the network device configures the terminal equipment to perform AI/ML assessment/monitoring on TX beam prediction, the network device may possibly not have information on how many and what types of SetBs are supported at the terminal equipment side, which is functionality-based LCM of AI/ML. In this case, the network device has information on the first AI/ML unit (a functionality of transmitting beam prediction), but has no information on the second AI/ML unit (am AI/ML model of each SetB).

For example, the performance indicator may be a given beam prediction accuracy of TOP-1, and/or a beam prediction accuracy of TOP-1 with a margin of 1 dB, or other KPIs used in discussions of NR Rel-18 (e.g. [RP-231766 TR 38.843 v1.0.0]). Here, the prediction accuracy (%) may be defined as a percentage of “Top-1 measured beams in Top-1 predicted beams”.

As described above, expected gains of using AI/ML are dependent on the preference of the network device. When the network device expects to lower reference signal overhead and beam selection delay, the network device expects to select a minimum SetB with an acceptable beam prediction accuracy, that is, the AI/ML unit has minimum input overhead.

In another situation, the network device using AI/ML expects that gains are for higher beam prediction accuracies, which may require reporting a highest SetB and its beam prediction accuracy, that is, the AI/ML unit has largest input overhead and a highest accuracy.

For configuring performance indicator information by the network device for the terminal equipment, if it is to reduce overhead, the information may instruct the terminal equipment to select a model with a minimum SetB, which may be close to an expected prediction accuracy. If it is for high prediction accuracy, the information may instruct the terminal equipment to select a model with a highest prediction accuracy.

For example, an example of a detailed configuration may be that:
in order to reduce overhead, the configuration signaling in step 3 may include:
AI/ML first unit information: the functionality indication for transmitting beam prediction may correspond to a functionality identifier determined in a process of reporting a UE functionality;
performance information: an acceptable TOP-1 prediction accuracy X (e.g. 80%), and possible values of the prediction accuracy may be predefined and indicated by indication information, such as multi-bit information;
performance indicator information: it indicates that the smaller the number of beams in SetB, the better, for example, such as being denoted by 1 bit. Or, a predicted offset value may be provided, such as 5%. This means that if the prediction accuracy is within a range from prediction accuracy X minus a prediction offset to prediction accuracy X (75%-80%), a minimum SetB shall be selected. A step size or value of the offset may be predefined. The prediction accuracy X here corresponds to a basic condition for activating AI/ML, the step size of the offset corresponds to a margin condition for dealing with the basic condition, and purposes of them are different.

For high prediction accuracies, the configuration signaling in step 3 may include:
the first AI/ML unit information: the functionality indication for transmitting beam prediction may correspond to a functionality identifier determined in a process of reporting the UE functionality;
performance information: a baseline TOP-1 prediction accuracy X (e.g. 80%), and potential values of the prediction accuracy may be predefined;
performance indicator information: indicates that the higher the prediction accuracy, the better, such as being denoted by 1 bit.

In the above two situations, the terminal equipment performs AI/ML assessment/monitoring, and selects a best second AI/ML unit that is able to satisfy performance requirements in step 4 to report. The terminal equipment may also select all second AI/ML units that are able to satisfy the performance requirements in step 4 to report, and at this time, the network side has the right of final decision.

For example, all second units having SetBs with prediction accuracies within the range from prediction accuracy X minus a prediction offset to prediction accuracy X (75%-80%) are reported, and the network selects a unit therefrom with lowest input overhead, or reports SetB input parameters or parameter indications of all units with reporting prediction accuracies higher than X, and selects a unit with a best performance.

In step 4, the network device configures the terminal equipment to report the selected second AI/ML unit for AI/ML activation.

The terminal equipment reports when the performance conditions are satisfied. Contents of the report may include: an AI/ML activation request, selected SetB information, that is, information on the number of SetB beams or the number of pieces of L1-RSRP, and prediction accuracy information of the unit.

Reporting modes include:
mode 1: transmitting an AI/ML activation request by the terminal equipment to the network device, and transmitting information on the selected unit by the terminal equipment when the network device further makes response; and
mode 2: transmitting the AI/ML activation request along with the information on the selected unit by the terminal equipment to the network device.

In some embodiments, the report may be transmitted via one or more of a dedicated PRACH, an SR (via a PUCCH), an MAC-CE, and an RRC message.

In some embodiments, a process of monitoring/assessing the inactive AI/ML unit at the network side includes the following steps:
step 1: configuring RS resources for management by the network device based on the terminal equipment capability report;
step 2: configuring a relevant reporting mode by the network device, such as configuring based on an existing CSI reporting framework;
step 3: configuring the AI/ML performance information and performance indicator information for assessment by the network device for the terminal equipment;
step 4: configuring the terminal equipment by the network device to perform CSI reporting based on the second AI/ML unit;
step 5: performing CSI reporting by the terminal equipment based on the second AI/ML unit; and
step 6: selecting a best AI/ML second unit, transmitting information on the selected unit to the terminal equipment, and performing AI/ML activation, by the network device.

In the description of the above embodiment, description of parts in consistence with monitoring/assessment of inactive AI/ML at the terminal equipment side are omitted.

In the above embodiment, one mode is to require the terminal equipment to report all prediction accuracies of all second AI/ML units and information on SetBs or each unit. This mode will result in relatively high reporting overhead.

Another mode is that if the network device expects high prediction accuracies, the network device may configure a basic prediction accuracy threshold for the terminal equipment and require the terminal equipment to report information on the second AI/ML unit satisfying the accuracy requirements, and/or corresponding prediction accuracy information.

If the network device is interested in reducing overhead of AI/ML units, the network device may configure expected unit overhead information for the terminal equipment, and require the terminal equipment to report the prediction accuracy of the second AI/ML unit satisfying the overhead request.

At the network device side, AI/ML performance will be further assessed. The network device decides to activate the second AI/ML unit selected by the terminal. Based on an assessment result, the network device may definitely activate the second AI/ML unit via the unit ID (if available) of the second AI/ML unit.

Or, the network device may configure the SetB information of the selected second AI/ML unit for activation thereof. For a SetB configuration, if the terminal has multiple second units, the terminal equipment shall select one second unit with a highest prediction accuracy in a most recent report.

A common issue between assessment at the terminal equipment side and assessment at the network device side is that in order to have reliable AI/ML activation and avoid ping-pong effects, an event counter or event timer may be configured during the assessment. This means that AI/ML activation may be requested or decided when an activation condition is continuously satisfied within the time of the event counter or continuously detected within a time period of the event timer.

### 3) Regarding Monitoring/Assessment of Switched Inactive AI/ML Units

There exist many similarities between part 3) and part 2), in which case an AI/ML unit is activated and run. A problem is to select one from inactive AI/ML units with relatively good performances and require the terminal equipment to switch and use the unit.

In functionality-based LCM, the network device learns that the first AI/ML unit is activated, and the network device may or may not learn which second AI/ML unit is running.

The network device may configure terminal equipments to monitor/assess inactive second AI/ML units.

In this configuration, similar to part 2), the network device configures the performance information, including the performance indicator information. However, the performance indicator information is based on the preference of the network device for using AI/ML units.

If it is to reduce overhead, the network device may configure expected overhead configuration for the terminal equipment and require the terminal equipment to feed back prediction accuracies. Or, the network device may configure prediction accuracies, and require the terminal equipment to feed back minimum overhead able to satisfy accuracy requests.

If it is for better performances, the network device may configure the terminal equipment to find a second AI/ML unit with a performance better than that of a running AI/ML unit. To avoid ping-pong effects, a performance offset may be configured. This means that only when the performance of the second AI/ML unit is better than that of an operating unit with a gain higher than an offset value, can a better second AI/ML unit be selected. In addition, an event counter or event timer may be configured. This means that only when an event with a higher performance is continuously detected on the counter, or when a time length of an event with a higher continuous performance is longer than a duration of the timer, can AI/ML unit switching from the terminal equipment to the network device be requested.

The overhead in the above embodiment may correspond to overhead of a model input parameter, such as the number of input RSs, and may correspond to overhead of an output parameter.

In some embodiments, as to the monitoring/assessment of inactive AI/ML units at the terminal equipment side, the process may include the following steps:
step 1: configuring RS resources by the network device for the terminal equipment for management based on the terminal equipment capability report;
step 2: configuring an AI/ML assessment report related to the terminal equipment by the network device, such as based on a CSI reporting framework;
step 3: configuring the terminal equipment by the network device to perform monitoring/assessment on inactive AI/ML units, including the performance information, the performance indicator information, and event trigger information;
step 4: configuring the terminal equipment with reporting related to AI/ML unit switching by the network device;
step 5: when the terminal equipment detects that the performance of the second AI/ML unit matches the performance information based on performance indicators, and/or an event trigger condition for AI/ML unit switching is satisfied, the terminal equipment reports/requests AI/ML unit switching, including input information of the selected AI/ML unit, assistance information of the selected AI/ML unit, and an ID of the selected AI/ML unit;
step 6: making response by the network device, transmitting an indication/configuration of switching to the terminal equipment according to the ID, input information, assistance information and condition information.

In the above process, one issue is that if the network device has AI/ML unit ID information, the network device may configure an ID of the selected AI/ML unit for switching. If the network device does not have such information, the network device needs to use input and output information obtained from the report of the terminal equipment or assistance information and condition information of the selected unit to indicate the AI/ML unit.

In some embodiments, the input information may be input configuration information, such as SetB information in beam management, or output configuration information, such as output information in CSI compression.

In some embodiments, the assistance information or condition information may be other conditions or parameters that may distinguish AI/ML units.

For example, different wireless scenarios may need to be supported by using different AI/ML units, such as indoor units and outdoor units. In addition, different moving speeds or mobilities may need different AI/ML units, such as units for low mobilities or units for high mobilities.

In some embodiments, the assistance information or condition information may be obtained by the network device via the terminal equipment capability report. Even there is no unit ID, with this assistance information or condition information, the network device and the terminal equipment may have a common understanding of the selected AI/ML unit.

In some embodiments, as to monitoring/assessment of inactive AI/ML at the network device side, the process may include the following steps:
step 1: configuring RS resources for management by the network device based on the terminal equipment capability report;
step 2: configuring reporting related to AI/ML assessment, such as based on a CSI reporting framework;
step 3: configuring AI/ML performance information and performance indicator information by the network device for the terminal equipment;
step 4: configuring the terminal equipment by the network device to report based on the second AI/ML unit, such as CSI reporting;
step 5: reporting by the terminal equipment based on the second AI/ML unit, including input information of the selected AI/ML unit, assistance information and condition information of the selected AI/ML unit, and an ID of the selected AI/MS unit; and
step 6: selecting a best AI/ML unit according to the ID, input information, output information, assistance information and condition information, and transmitting an indication/configuration of switching to the terminal equipment, by the network device.

In the above embodiment where the network side performs final assessment to determine the selected AI/ML unit, if it unable to be indicated to the terminal equipment via the AI/ML ID and is indicated to the terminal equipment via other implicit information (such as the input information, output information, assistance information, and condition information, etc.), when it corresponds to multiple second AI/ML units, the terminal equipment selects a second AI/ML unit with a best corresponding indicator to activate or switch based on the performance indicators configured at the time of reporting.

The above implementations only illustrate embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that embodiments of this disclosure are able to support and clearly define a process of monitoring/assessing performances of inactive AI/ML models/functionalities, and use of gains of AI/ML becomes reliable.

### Embodiment of a Second Aspect

Embodiments of this disclosure provide an information transmission method, which shall be described from a network device side. The second embodiment may be implemented in combination with the embodiment of the first aspect, or may be implemented separately, with contents identical to those in the embodiment of the first aspect being not going to be repeated herein any further.

FIG. 11 is another schematic diagram of the information transmission method of embodiments of this disclosure. As shown in FIG. 11, the method includes:

1101: transmitting first configuration information or second configuration information related to AI/ML unit performance assessment or selection by a network device to a terminal equipment.

In some embodiments, the first configuration information includes one or more of performance information, activation trigger information, or AI/ML unit indication information related to performance assessment or selection associated with AI/ML activation.

In some embodiments, the second configuration information includes one or more of performance information related to performance assessment or selection related to AI/ML switching, switch trigger information, and AI/ML unit indication information.

Reference may be made to the disclosure contained in the embodiment of the first aspect for specific actions, specific contents of the first configuration information and the second configuration information, and other behaviors or other information received/transmitted by the network device in operation 1101, which shall not be repeated herein any further.

The above implementations only illustrate embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that embodiments of this disclosure are able to support and clearly define a process of monitoring/assessing performances of inactive AI/ML models/functionalities, and use of gains of AI/ML becomes reliable.

### Embodiment of a Third Aspect

Embodiments of this disclosure provide an information transmission apparatus. The apparatus may be, for example, a terminal equipment, or may be one or some components or assemblies configured in the terminal equipment. This embodiment corresponds to the embodiment of the first aspect, in which contents identical to those in the embodiment of the first aspect shall not be described herein any further.

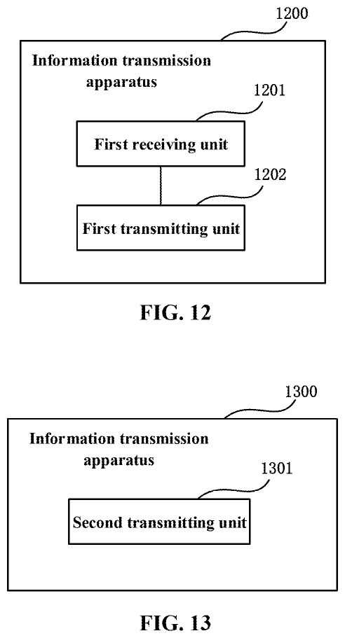

FIG. 12 is a schematic diagram of the information transmission apparatus of embodiments of this disclosure. As shown in FIG. 12, an information transmission apparatus 1200 includes:
a first receiving unit 1201 configured to receive first configuration information or second configuration information related to AI/ML unit performance assessment or selection from a network device.

In some embodiments, the first configuration information includes one or more of performance information, activation trigger information, or AI/ML unit indication information related to performance assessment or selection associated with AI/ML activation.

In some embodiments, the second configuration information includes one or more of performance information, switching trigger information, or AI/ML unit indication information related to performance assessment or selection associated with AI/ML switching.

In some embodiments, the performance information includes one or more pieces of the following information for assessing an AI/ML unit related to performance indicators:
a performance threshold for assessing AI/ML activation by a terminal side;
a performance threshold range for assessing AI/ML activation by the terminal side;
a reporting performance threshold for assessing AI/ML activation by a network side; and
a reporting performance threshold range for assessing AI/ML activation by the network side.

In some embodiments, the performance information further includes one or more pieces of the following performance preference indication information:
indication information for selecting an AI/ML unit with a best performance;
indication information for selecting an AI/ML unit with a performance higher than or equal to the performance threshold or with a best reporting performance threshold;
indication information for selecting an AI/ML unit with a performance satisfying the performance threshold range or the reporting performance threshold range;
indication information for selecting an AI/ML unit having a corresponding input reference signal with lowest overhead;
indication information for selecting an AI/ML unit having a corresponding output signal with lowest overhead;
indication information for selecting an AI/ML unit satisfying one of the performance indicators and having a corresponding input reference signal with lowest overhead; and
indication information for selecting an AI/ML unit satisfying one of the performance indicators and having a corresponding output signal with lowest overhead.

In some embodiments, the activation trigger information includes one or more pieces of the following information:
a counter parameter triggering an activation request;
a timer parameter triggering an activation request; and
other event parameters triggering an activation requests.

In some embodiments, the AI/ML unit indication information includes one or more pieces of the following information:
AI/ML assistance information used to indicate assessment of AI/ML units having the assistance information;
AI/ML input parameter or output parameter information used to indicate assessment of AI/ML units having the input parameter or output parameter; and
AI/ML condition information used to indicate assessment of AI/ML units satisfying the condition information.

In some embodiments, the performance information includes one or more pieces of the following information related to the performance indicators for assessing an AI/ML unit:
a performance threshold for assessing AI/ML switching by the terminal side;
a performance threshold range for assessing AI/ML switching by the terminal side;
a reporting performance threshold for assessing AI/ML switching by the network side; and
a reporting performance threshold range for assessing AI/ML switching by the network side.

In some embodiments, the performance information further includes one or more pieces of the following performance preference indication information:
selecting an AI/ML unit with a performance higher than that of an active AI/ML unit and a performance difference higher than the performance threshold or the reporting performance threshold;
selecting an AI/ML unit with a performance difference falling within the performance threshold range or the reporting performance threshold range in comparison with an active AI/ML unit;
selecting an AI/ML unit with a performance difference falling within the performance threshold range or the reporting performance threshold range in comparison with an active AI/ML unit and with an input reference signal or output information having overhead lower than that of the active AI/ML unit; and
selecting an AI/ML unit with a performance difference less than the performance threshold or the reporting performance threshold in comparison with an active AI/ML unit and with an input reference signal or output information having overhead lower than that of the active AI/ML unit.

In some embodiments, the switching trigger information includes one or more pieces of the following information:
a counter parameter triggering an AI/ML switching request;
a timer parameter triggering an AI/ML switching request; and
other event parameters triggering an AI/ML switching request.

In some embodiments, the AI/ML unit indication information includes one or more pieces of the following information:
AI/ML assistance information for indicating assessment of comparison between an AI/ML unit having the assistance information and an active AI/ML unit;
AI/ML input parameter or output parameter information for indicating assessment of comparison between an AI/ML unit having the input parameter or output parameter and an active AI/ML unit; or
AI/ML condition information for indicating assessment of comparison between an AI/ML unit satisfying the condition information and an active AI/ML unit.

In some embodiments, corresponding to the first configuration information and/or the second configuration information, the terminal equipment further receives corresponding reporting configuration information from the network device.

In some embodiments, the reporting configuration information includes a reporting behavior after indicating the terminal equipment to perform the performance assessment or selection on the AI/ML unit, and includes one or more of the following configurations related to reporting content:
configuration related to an AI/ML switching or activation request;
information and configuration related to an AI/ML switching or activation unit;
information and configuration related to an AI/ML switching or candidate unit reporting configuration related to AI/ML unit input configuration information;
reporting configuration related to AI/ML unit output configuration information;
reporting configuration related to AI/ML unit assistance information;
reporting configuration related to AI/ML unit condition information; or
reporting configuration related to AI/ML performance information.

In some embodiments, the reporting configuration information includes a reporting behavior after indicating the terminal equipment to perform the performance assessment or selection on the AI/ML unit, and the configurations related to reporting content include one or more of the following contents:
input configuration information of a selected AI/ML unit and/or performance information of a selected AI/ML unit;
output configuration information of the selected AI/ML unit and/or performance information of the selected AI/ML unit;
assistance information of the selected AI/ML unit and/or performance information of the selected AI/ML unit;
condition information of the selected AI/ML unit and/or performance information of the selected AI/ML unit; and
an identifier of the selected AI/ML unit and/or performance information of the selected AI/ML unit.

In some embodiments, the selected AI/ML unit is one or more units, and/or
the selected AI/ML unit is in an inactive state.

In some embodiments, selection of the contents is based on the first configuration information or the second configuration information, and/or, a format of reporting the contents is based on the reporting configuration information.

In some embodiments, the reporting configuration information includes a reporting behavior after indicating the terminal equipment to perform the performance assessment or selection on the AI/ML unit, and includes one or more of the following reporting modes and resource configuration information:
periodic reporting, aperiodic reporting, or semi-persistent reporting;
configuring a dedicated PRACH resource, and performing trigger reporting of an AI/ML switching or activation request; or
performing reporting based on a dedicated PUCCH or a dedicated MAC CE or a dedicated RRC message.

In some embodiments, the AI/ML unit is a first AI/ML unit or a second AI/ML unit, or includes a first AI/ML unit and a second AI/ML unit,
the first AI/ML unit including one or more second AI/ML units.

In some embodiments, the apparatus 1200 further includes:
a first transmitting unit 1202 configured to report capability information of the terminal equipment to the network device,
the capability information of the terminal equipment including AI/ML unit information, the AI/ML unit information including one or more pieces of the following information:
according to a query of the network device, whether the first AI/ML unit and/or the second AI/ML unit is/are supported;
whether there is only one first AI/ML unit and/or second AI/ML unit or there are multiple first AI/ML units and/or second AI/ML units;
a number/numbers of the first AI/ML unit and/or the second AI/ML unit that is/are queried;
the number of the second AI/ML units in the first AI/ML unit that is queried;
a model identifier of the AI/ML unit that is queried;
assistance information of the AI/ML unit that is queried;
condition information of the AI/ML unit that is queried; and
input and output configuration information of the AI/ML unit that is queried.

In some embodiments, content and/or a format of the reporting is/are predefined and/or configured by the network device.

The above implementations only illustrate embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that embodiments of this disclosure are able to support and clearly define a process of monitoring/assessing performances of inactive AI/ML models/functionalities, and use of gains of AI/ML becomes reliable.

### Embodiment of a Fourth Aspect

Embodiments of this disclosure provide an information transmission apparatus. The apparatus may be, for example, a network device, or may be one or some components or assemblies configured in the network device. This embodiment corresponds to the embodiment of the second aspect, in which contents identical to those in the embodiment of the second aspect shall not be described herein any further.

FIG. 13 is a schematic diagram of the information transmission apparatus of embodiments of this disclosure. As shown in FIG. 13, an information transmission apparatus 1300 includes:
a second transmitting unit 1301 configured to transmit first configuration information or second configuration information related to AI/ML unit performance assessment or selection to a terminal equipment.

In some embodiments, the first configuration information includes one or more of performance information, activation trigger information, or AI/ML unit indication information related to performance assessment or selection associated with AI/ML activation.

In some embodiments, the second configuration information includes one or more of performance information, switching trigger information, or AI/ML unit indication information related to performance assessment or selection associated with AI/ML switching.

The above implementations only illustrate embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that embodiments of this disclosure are able to support and clearly define a process of monitoring/assessing performances of inactive AI/ML models/functionalities, and use of gains of AI/ML becomes reliable.

### Embodiment of a Fifth Aspect

Embodiments of this disclosure provide a terminal equipment, including the information transmission apparatus as described in the embodiment of the third aspect.

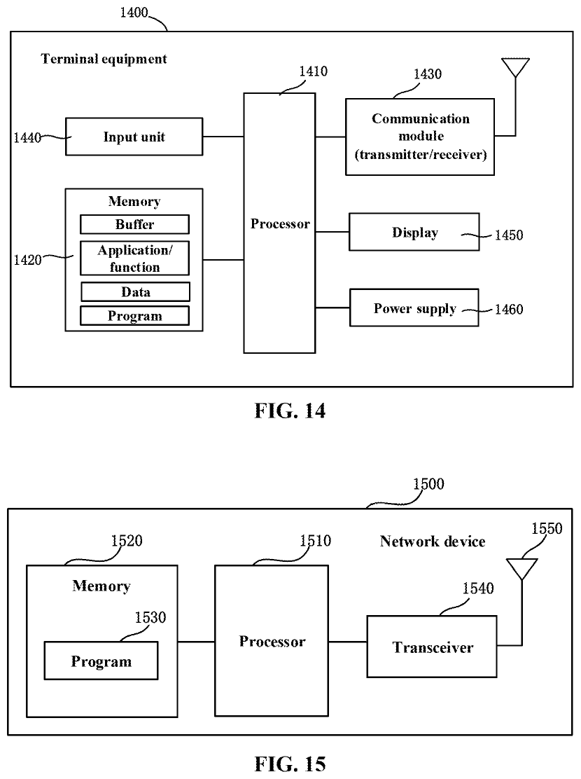

FIG. 14 is a block diagram of a systematic structure of the terminal equipment of embodiments of this disclosure. As shown in FIG. 14, a terminal equipment 1400 may include a processor 1410 and a memory 1420, the memory 1420 storing data and a program and being coupled to the processor 1410. It should be noted that this figure is illustrative only, and other types of structures may also be used, to supplement or replace this structure and achieve a telecommunications function or other functions.

In one implementation, functions of the information transmission apparatus may be integrated into the processor 1410.

The processor 1410 may be configured to: for a terminal equipment having one or more AI/ML features, receive first configuration information or second configuration information related to AI/ML unit performance assessment or selection by the terminal equipment from a network device.

In another implementation, the information transmission apparatus and the processor 1410 may be configured separately; for example, the information transmission apparatus may be configured as a chip connected to the processor 1410, and the functions of the information transmission apparatus are executed under control of the processor 1410.

As shown in FIG. 14, the terminal equipment 1400 may further include a communication module 1430, an input unit 1440, a display 1450, and a power supply 1460. It should be noted that the terminal equipment 1400 does not necessarily include all the parts shown in FIG. 14, and the above components are not necessary. Furthermore, the terminal equipment 1400 may include parts not shown in FIG. 14, and the related art may be referred to.

As shown in FIG. 14, the processor 1410 is sometimes referred to as a controller or an operational control, which may include a microprocessor or other processor devices and/or logic devices. The processor 1410 receives input and controls operations of components of the terminal equipment 1400.

In some embodiments, the memory 1420 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1410 may execute programs stored in the memory 1420, so as to realize information storage or processing, etc. Functions of other parts are similar to those of the related art, which shall not be described herein any further. The parts of the terminal equipment 1400 may be realized by specific hardware, firmware, software, or any combination thereof, without departing from the scope of this disclosure.

The above implementations only illustrate embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that embodiments of this disclosure are able to support and clearly define a process of monitoring/assessing performances of inactive AI/ML models/functionalities, and use of gains of AI/ML becomes reliable.

### Embodiment of a Sixth Aspect

Embodiments of this disclosure provide a network device, including the information transmission apparatus as described in the embodiment of the fourth aspect.

FIG. 15 is a block diagram of a systematic structure of the network device of an embodiment of this disclosure. As shown in FIG. 15, a network device 1500 may include a processor 1510 and a memory 1520, the memory 1520 being coupled to the processor 1510. Wherein, the memory 1520 may store various data, and furthermore, it may store a program 1530 for information processing, and execute the program 1530 under control of the processor 1510.

In one implementation, functions of the information transmission apparatus may be integrated into the processor 1510.

The processor 1510 may be configured to: transmit first configuration information or second configuration information related to AI/ML unit performance assessment or selection by the network device to a terminal equipment.

In another implementation, the information transmission apparatus and the processor 1510 may be configured separately; for example, the information transmission apparatus may be configured as a chip connected to the processor 1510, and the functions of the information transmission apparatus are executed under control of the processor 1510.

Furthermore, as shown in FIG. 15, the network device 1500 may include a transceiver 1540, and an antenna 1550, etc. Wherein, functions of the above components are similar to those in the related art, and shall not be described herein any further. It should be noted that the second network device 1500 does not necessarily include all the parts shown in FIG. 15, and furthermore, the second network device 1500 may include parts not shown in FIG. 15, and the related art may be referred to.

The above implementations only illustrate embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that embodiments of this disclosure are able to support and clearly define a process of monitoring/assessing performances of inactive AI/ML models/functionalities, and use of gains of AI/ML becomes reliable.

### Embodiment of a Seventh Aspect

Embodiments of this disclosure provide a communication system, including the terminal equipment as described in the embodiment of the fifth aspect and/or the network device as described in the embodiment of the sixth aspect.

For example, reference may be made to FIG. 1 for a structure of the communication system.

As shown in FIG. 1, the communication system 100 includes the network device 101 and the terminal equipment 102. The network device 101 is identical to the network device described in the embodiment of the sixth aspect, and the terminal equipment 102 is identical to the terminal equipment described in the embodiment of the fifth aspect, with repeated contents being not going to be described herein any further.

An embodiment of this disclosure provides a computer readable program, which, when executed in a terminal equipment, will cause the terminal equipment to carry out the information transmission method as described in the embodiment of the first aspect.

An embodiment of this disclosure provides a computer readable medium, including a computer readable program, which will cause a terminal equipment to carry out the information transmission method as described in the embodiment of the first aspect.

An embodiment of this disclosure provides a computer readable program, which, when executed in a network device, will cause the network device to carry out the information transmission method as described in the embodiment of the second aspect.

An embodiment of this disclosure provides a computer readable medium, including a computer readable program, which will cause a network device to carry out the information transmission method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.
1. An information transmission method, the method including:
for a terminal equipment having one or more AI/ML features, receiving first configuration information or second configuration information related to AI/ML unit performance assessment or selection by the terminal equipment from a network device, wherein,
for an AI/ML feature of the terminal equipment, when all AI/ML units included in the AI/ML feature are not activated, the first configuration information includes performance information related to determining activation of the AI/ML unit, and when one AI/ML unit included in the AI/ML feature is activated, the second configuration information includes performance information for determining AI/ML unit switching.
2. The method according to supplement 1, wherein corresponding to the first configuration information and/or the second configuration information, the terminal equipment further receives corresponding reporting configuration information from the network device, the reporting configuration information including a part of information of the first configuration information and/or the second configuration information.
3. An information transmission method, the method including:
for a terminal equipment having one or more AI/ML features, receiving third configuration information related to AI/ML unit performance assessment or selection from a network device.
4. The method according to supplement 3, wherein the third configuration information includes one or more performance information, activation/switching trigger information or AI/ML unit indication information related to performance assessment or selection associated with AI/ML activation/switching.
5. The method according to supplement 4, wherein the performance information includes one or more pieces of the following information for assessing an AI/ML unit related to performance indicators:
a performance threshold for assessing AI/ML activation by a terminal side;
a performance threshold range for assessing AI/ML activation by the terminal side;
a reporting performance threshold for assessing AI/ML activation by a network side; and
a reporting performance threshold range for assessing AI/ML activation by the network side.
6. The method according to any one of supplements 1-5, wherein,
the AI/ML unit corresponds to an AI/ML feature and/or an AI/ML functionality and/or an AI/ML logical model and/or an AI/ML physical model.
7. The method according to supplement 6, wherein,
the first AI/ML feature includes one or more second AI/ML features, or the first AI/ML feature includes one or more first AI/ML functionalities; and/or,
the first AI/ML functionality includes one or more second AI/ML functionalities, or the first AI/ML functionality includes one or more first models; and/or,
the first AI/ML model includes one or more second AI/ML models.
8. An information transmission method, the method including:
transmitting first configuration information or second configuration information or third configuration information related to AI/ML unit performance assessment or selection by a network device to a terminal equipment.
9. The method according to supplement 8, wherein,
the first configuration information includes one or more of performance information, activation trigger information, or AI/ML unit indication information related to performance assessment or selection associated with AI/ML activation,
the second configuration information includes one or more of performance information, switching trigger information, or AI/ML unit indication information related to performance assessment or selection associated with AI/ML switching,
and the third configuration information includes one or more performance information, activation/switching trigger information or AI/ML unit indication information related to performance assessment or selection associated with AI/ML activation/switching.
10. A communication system, including a terminal equipment and a network device,
the terminal equipment including a memory and a processor, the memory storing a computer program, and the processor being configured to execute the computer program to carry out the information transmission method as described in any one of supplements 1-7,
and the network device including a memory and a processor, the memory storing a computer program, and the processor being configured to execute the computer program to carry out the information transmission method as described in either one of supplements 8-9.

1. An information transmission apparatus, provided in a terminal equipment having one or more AI/ML (artificial intelligence/machine learning) features, the apparatus comprising:
a first receiver configured to receive first configuration information or second configuration information related to AI/ML unit performance assessment or selection from a network device.

2. The apparatus according to claim 1, wherein,
the first configuration information comprises one or more of performance information, activation trigger information, or AI/ML unit indication information related to performance assessment or selection associated with AI/ML activation.

3. The apparatus according to claim 1, wherein,
the second configuration information comprises one or more of performance information, switching trigger information, or AI/ML unit indication information related to performance assessment or selection associated with AI/ML switching.

4. The apparatus according to claim 2, wherein the performance information comprises one or more pieces of the following information for assessing an AI/ML unit related to performance indicators:
a performance threshold for assessing AI/ML activation by a terminal side;
a performance threshold range for assessing AI/ML activation by a terminal side;
a reporting performance threshold for assessing AI/ML activation by a network side; or
a reporting performance threshold range for assessing AI/ML activation by a network side.

5. The apparatus according to claim 4, wherein the performance information further comprises one or more pieces of the following performance preference indication information:
indication information for selecting an AI/ML unit with a best performance;
indication information for selecting a best AI/ML unit with a performance higher than or equal to the performance threshold or the reporting performance threshold;
indication information for selecting an AI/ML unit with a performance satisfying the performance threshold range or the reporting performance threshold range;
indication information for selecting an AI/ML unit having a corresponding input reference signal with lowest overhead;
indication information for selecting an AI/ML unit having a corresponding output signal with lowest overhead;
indication information for selecting an AI/ML unit satisfying one of the performance indicators and having a corresponding input reference signal with lowest overhead; or
indication information for selecting an AI/ML unit satisfying one of the performance indicators and having a corresponding output signal with lowest overhead.

6. The apparatus according to claim 2, wherein the activation trigger information comprises one or more pieces of the following information:
a counter parameter triggering an activation request;
a timer parameter triggering an activation request; or
other event parameters triggering an activation request.

7. The apparatus according to claim 2, wherein the AI/ML unit indication information comprises one or more pieces of the following information:
AI/ML assistance information for indicating assessment of an AI/ML unit having the assistance information;
AI/ML input parameter or output parameter information for indicating assessment of an AI/ML unit having the input parameter or output parameter; or
AI/ML condition information for indicating assessment of an AI/ML unit satisfying the condition information.

8. The apparatus according to claim 3, wherein the performance information comprises one or more pieces of the following information for assessing an AI/ML unit related to performance indicators:
a performance threshold for assessing AI/ML switching by a terminal side;
a performance threshold range for assessing AI/ML switching by a terminal side;
a reporting performance threshold for assessing AI/ML switching by a network side; or
a reporting performance threshold range for assessing AI/ML switching by a network side.

9. The apparatus according to claim 8, wherein the performance information further comprises one or more pieces of the following performance preference indication information:
selecting an AI/ML unit with a performance higher than that of an active AI/ML unit and a performance difference higher than the performance threshold or the reporting performance threshold;
selecting an AI/ML unit with a performance difference falling within the performance threshold range or the reporting performance threshold range in performance comparison with an active AI/ML unit;
selecting an AI/ML unit with a performance difference falling within the performance threshold range or the reporting performance threshold range in performance comparison with an active AI/ML unit and with an input reference signal or output information having overhead lower than that of the active AI/ML unit; or
selecting an AI/ML unit with a performance difference less than the performance threshold or the reporting performance threshold in performance comparison with an active AI/ML unit and with an input reference signal or output information having overhead lower than that of the active AI/ML unit.

10. The apparatus according to claim 3, wherein the switching trigger information comprises one or more pieces of the following information:
a counter parameter triggering an AI/ML switching request;
a timer parameter triggering an AI/ML switching request; or
other event parameters triggering an AI/ML switching request.

11. The apparatus according to claim 3, wherein the AI/ML unit indication information comprises one or more pieces of the following information:
AI/ML assistance information for indicating assessment of comparison between an AI/ML unit having the assistance information and an active AI/ML unit;
AI/ML input parameter or output parameter information for indicating assessment of comparison between an AI/ML unit having the input parameter or output parameter and an active AI/ML unit; or
AI/ML condition information for indicating assessment of comparison between an AI/ML unit satisfying the condition information and an active AI/ML unit.

12. The apparatus according to claim 1, wherein corresponding to the first configuration information and/or the second configuration information, the terminal equipment further receives corresponding reporting configuration information from the network device.

13. The apparatus according to claim 12, wherein,
the reporting configuration information comprises a reporting behavior after indicating the terminal equipment to perform the performance assessment or selection on the AI/ML unit, and the reporting configuration information further comprises one or more of the following configurations related to reporting content:
configuration related to an AI/ML switching or activation request;
information and configuration related to an AI/ML switching or activation unit;
information and configuration related to an AI/ML switching or candidate unit
reporting configuration related to AI/ML unit input configuration information;
reporting configuration related to AI/ML unit output configuration information;
reporting configuration related to AI/ML unit assistance information;
reporting configuration related to AI/ML unit condition information; or
reporting configuration related to AI/ML performance information.

14. The apparatus according to claim 13, wherein,
the reporting configuration information comprises a reporting behavior after indicating the terminal equipment to perform the performance assessment or selection on the AI/ML unit, and the configurations related to reporting content comprise one or more of the following contents:
input configuration information of a selected AI/ML unit and/or performance information of a selected AI/ML unit;
output configuration information of a selected AI/ML unit and/or performance information of a selected AI/ML unit;
assistance information of a selected AI/ML unit and/or performance information of a selected AI/ML unit;
condition information of a selected AI/ML unit and/or performance information of a selected AI/ML unit; or
an identifier of the selected AI/ML unit and/or performance information of a selected AI/ML unit.

15. The apparatus according to claim 14, wherein,
the selected AI/ML unit is one or more units, and/or
the selected AI/ML unit is in an inactive state.

16. The apparatus according to claim 14, wherein,
selection of the contents is based on the first configuration information or the second configuration information, and/or,
a format of reporting the contents is based on the reporting configuration information.

17. The apparatus according to claim 12, wherein,
the reporting configuration information comprises reporting after indicating the terminal equipment to perform the performance assessment or selection on the AI/ML unit, and the reporting configuration information further comprises one or more of the following reporting modes and resource configuration information:
periodic reporting, aperiodic reporting, or semi-persistent reporting;
configuring a dedicated PRACH resource, and performing trigger reporting of an AI/ML switching or activation request; or
performing reporting based on a dedicated PUCCH or a dedicated MAC CE or a dedicated RRC message.

18. The apparatus according to claim 1, wherein,
the AI/ML unit is a first AI/ML unit or a second AI/ML unit, or the AI/ML unit comprises a first AI/ML unit and a second AI/ML unit,
the first AI/ML unit comprising one or more second AI/ML units.

19. The apparatus according to claim 1, the apparatus further comprising:
a first transmitter configured to report capability information of the terminal equipment to the network device,
the capability information of the terminal equipment comprising AI/ML unit information, the AI/ML unit information comprising one or more pieces of the following information:
according to a query of the network device, whether a first AI/ML unit and/or a second AI/ML unit is/are supported;
whether there is only one first AI/ML unit and/or second AI/ML unit or there are multiple first AI/ML units and/or second AI/ML units;
a number/numbers of a first AI/ML unit and/or a second AI/ML unit that is/are queried;
the number of second AI/ML units in a first AI/ML unit that is queried;
a model identifier of a AI/ML unit that is queried;
assistance information of a AI/ML unit that is queried;
condition information of a AI/ML unit that is queried; or
input and output configuration information of a AI/ML unit that is queried.

20. The apparatus according to claim 19, wherein,
reporting content and/or a reporting format is/are predefined and/or configured by the network device.
